(19) United States
(12) Patent Application Publication
(10) Pub. No.: US 2018/0364671 A1
(43) Pub. Date: Dec. 20, 2018

(54) SAFETY CONTROLLER WITH CYBER-SECURE MAINTENANCE OVERRIDE

(71) Applicant: HONEYWELL INTERNATIONAL INC., MORRIS PLAINS, NJ (US)

(72) Inventors: AAD VAN WENSEN, TILBURG (NL); ANTON BEERENS, DE MOER (NL)

(21) Appl. No.: 16/000,229

(22) Filed: Jun. 5, 2018

Related U.S. Application Data
(60) Provisional application No. 62/520,898, filed on Jun. 16, 2017.

(51) Int. Cl. G05B 19/042

(52) U.S. Cl. CPC G05B 19/0428

(57) ABSTRACT

A safety controller includes an interface circuit coupled to IO devices coupled to field devices coupled to processing equipment, a primary controller including a primary processor and a secondary controller including a secondary processor each for implementing control loops that automatically take actions by sending control signals to the actuators, and a bus coupling the interface circuit and a mode-switching multi-key switch. The multi-key switch includes a force (FRC) enable key-switch having a FRC enable On position for entering a maintenance override mode and an OFF position, and a FRC reset key-switch having a FRC reset position for removal of maintenance overrides. Following entry of a first maintenance override and the FRC enable key-switch is then returned to the OFF position, there are no changes to the first maintenance override while new maintenance overrides cannot be added until the FRC enable key-switch is set to the FRC On position again.

### CROSS REFERENCE TO RELATED APPLICATIONS

This application claims the benefit of Provisional Application Ser. No. 62/520,898 entitled “CONTROLLER WITH CYBER-SECURE MAINTENANCE OVERRIDE”, filed on Jun. 16, 2017, which is herein incorporated by reference in its entirety.

### FIELD

Disclosed embodiments relate to industrial control systems, including safety controllers.

### BACKGROUND

An industrial facility, such as an industrial processing facility (or plant), to implement a fault-tolerant industrial process control system can include a safety instrumented system (SIS) for monitoring and overriding the process control provided by the process control system to maximize the likelihood of safe operation of the processing plant. A safety controller as known in the art of process control is a device or combination of devices connected to each another which receive process signals from sensors and uses these signals to produce output control signals using logic operations and, if needed, by further data processing steps. These output control signals are coupled to control actuators which carry out specific actions on the various processing equipment.

A distinguishing feature of a safety controller in contrast to a conventional process controller is that the safety controller always ensures that potentially dangerous apparatus are being controlled is in a safe state, which is implemented by running safety control programs. This safety requirement even applies when a malfunction occurs within the safety controller itself or in a device in the processing system (e.g., an Input/Output (10) module, sensor or actuator, or processing equipment) which is connected to it. Safety controllers are therefore subject to stringent requirements for their own fail safety, which results in considerable additional effort during their design development and manufacture. Generally, safety controllers require special licensing from responsible supervisory government authorities before they can be used, such as from professional societies dealing with work safety or from a technical supervisory association. The safety controller must also comply with specific safety standards depending on their geographic location, such as in Europe defined in the European Machine safety standard EN 954-1 which is used as an essential base for the risk analysis of safety-related components of industrial controls.

A typical safety controller of a SIS (e.g., such as implemented by a programmable logic controller (PLC)) runs stored safety control programs and provides at least a maintenance override mode using a force (FRC) enable position which allows entering a maintenance override mode. The safety controller is generally located in a control room of the plant, but can also be located in remote locations such as well heads or unmanned platforms. A key switch provides the FRC enable ON position and a FRC enable OFF position for enabling the maintenance override mode to be implemented.

From government safety regulations it is generally mandatory to remove all maintenance overrides with a single hardware switch action. It is believed that in all known cases for removing active maintenance overrides the same key-switch is returned by the user to the maintenance disabled state by moving from the FRC enable ON position to the FRC enable OFF position for the single key-switch arrangement, and from the FRC reset OFF position to the FRC reset ON position for the 2 key-switch arrangement.

### SUMMARY

This Summary briefly indicates the nature and substance of this Disclosure. It is submitted with the understanding that it will not be used to interpret or limit the scope or meaning of the claims.

It is recognized herein as more and more customers for a system have maintenance overrides that are active for a relatively long duration, such as during a plant overhaul, as part of a stand-by strategy, or due to long spare part delivery times, while the key-switch of the controller is in the FRC enable ON position enabling the maintenance override mode, the controller is susceptible to cyber-security risks. This cyber-security susceptibility is because while in the maintenance override mode all override enabled points in the plant including input/output devices (IOs), field devices and processing equipment are exposed to all attackers that have a forcing-capable communication path to the SIS, including the digital and analog outputs of IO devices that drive safety critical actuators coupled to processing equipment during such maintenance overrides. These cyber-security risks can comprise direct-access attacks (such as driving an input or output to an unsafe value) or tampering (changing parameters, such as the temperature of a burner).

Disclosed embodiments include controllers that comprise two FRC key-switches including a FRC enable key-switch with a FRC enable On position for entering the maintenance override mode, and a dedicated FRC reset key-switch that has a reset position for clearing (resetting) the ‘active’ maintenance overrides entered while in the maintenance override mode (while the FRC enable is On). In this disclosed arrangement, the FRC enable key-switch can be returned by a user to the FRC enable off (disabled) position which changes the safety controller state back to the run mode with no changes to the currently active maintenance override(s), yet new maintenance overrides cannot be added until the FRC enable key-switch is set to the maintenance override mode (where new maintenance overrides can be added) until the FRC enable is set to FRC enable ON again. This arrangement reduces the maintenance override mode time window (with FRC enable ON) to the time it takes to set a force (typically less than a minute) which reduces the cyber-attack time window from the time it take to complete the maintenance (typically weeks) to the time it takes to set the forces (typically minutes).

### BRIEF DESCRIPTION OF THE DRAWINGS

FIG. 1A is diagram depicting a control system were the safety controller has a disclosed multi-key switch including a dedicated maintenance override key-switch for the removal of active maintenance overrides, according to an example embodiment.

FIG. 1B is a block diagram representation of a disclosed safety controller.

FIG. 2 shows an example multi-key switch including a dedicated FRC reset key-switch for the removal of active maintenance overrides.

FIG. 3 is a flow chart that shows steps in a method of operating a safety controller with a multi-key switch including a dedicated FRC reset key-switch for the removal of active maintenance overrides.

### DETAILED DESCRIPTION

Disclosed embodiments are described with reference to the attached figures, wherein like reference numerals, are used throughout the figures to designate similar or equivalent elements. The figures are not drawn to scale and they are provided merely to illustrate aspects disclosed herein. Several disclosed aspects are described below with reference to example applications for illustration. It should be understood that numerous specific details, relationships, and methods are set forth to provide a full understanding of the embodiments disclosed herein.

One having ordinary skill in the relevant art, however, will readily recognize that the disclosed embodiments can be practiced without one or more of the specific details or with other methods. In other instances, well-known structures or operations are not shown in detail to avoid obscuring aspects disclosed herein. Disclosed embodiments are not limited by the illustrated ordering of acts or events, as some acts may occur in different orders and/or concurrently with other acts or events. Furthermore, not all illustrated acts or events are required to implement a methodology in accordance with this Disclosure.

Also, the terms “coupled to” or “couples with” (and the like) as used herein without further qualification are intended to describe either an indirect or direct electrical connection. Thus, if a first device “couples” to a second device, that connection can be through a direct electrical connection where there are only parasitics in the pathway, or through an indirect electrical connection via intervening items including other devices and connections. For indirect coupling, the intervening item generally does not modify the information of a signal but may adjust its current level, voltage level, and/or power level.

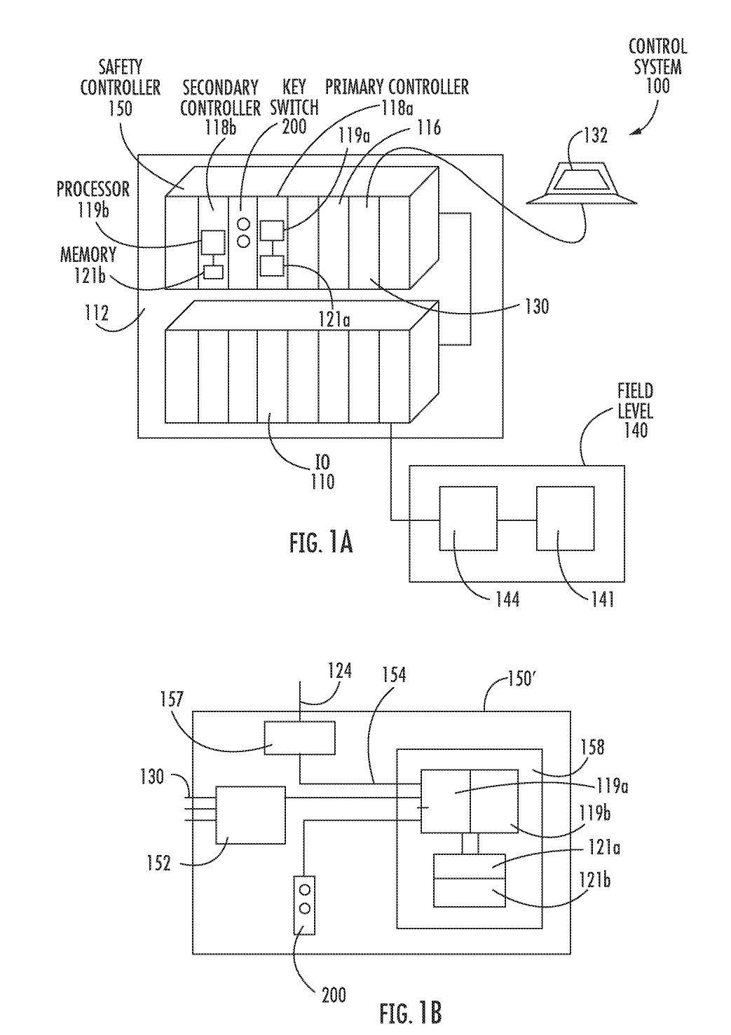

FIG. 1A is block diagram depiction of a control system 100 comprising a disclosed safety controller 150 for implementing a cyber-secure maintenance override. The safety controller 150 including a secondary processor 119b having associated secondary memory 121b and a parallel connected primary controller 118a including a processor 119a having an associated memory 121a are each coupled to IO modules 110 which couple to a field level 140 that includes sensors and actuators 144 associated with the processes run by the processing equipment 141. The process may include standard processes, such as those of controlling factory equipment, and safety processes related to a safety applications. The safety controller 150 allows execution of both safety control when the secondary processor 119b is active and standard control programs when the primary controller 118a is active.

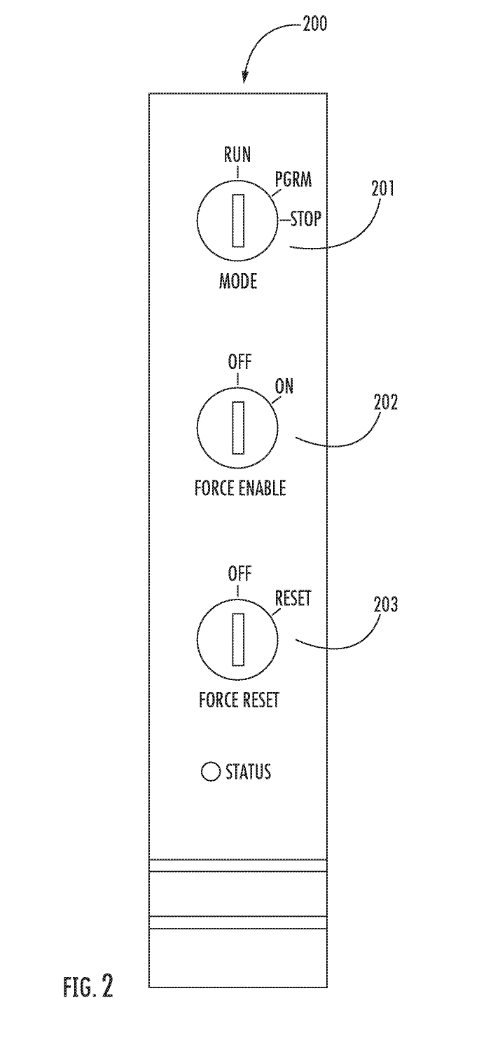

The safety controller 150 includes a housing 112. The safety controller 150 includes a disclosed multi-key switch 200 (see the multi-key switch 200 shown in FIG. 2 described below) that has a dedicated FRC reset key-switch 203 for the removal of active maintenance overrides. The multi-key switch 200 comprises a hardware switch which is generally needed to meet government safety regulations. As known in the art of switches, hardware switches use an underlying switch chip or driver to handle all of the switching directly, while in contrast software switches do this in software or at the firmware level.

The processors 119a and 119b can comprise a digital signal processor (DSP), a microcontroller, an application specific integrated circuit (ASIC), a general processor, or any other combination of one or more integrated processing devices. The safety controller 150 also is shown including a serial communication port 130 (such as an RS-232 port) that allows it to communicate directly with a programming terminal 132 shown by example in FIG. 1A as being a portable computer. A power supply 116 is also shown for the safety controller 150.

FIG. 1B is a block diagram representation of a disclosed safety controller shown as 150′. The safety controller 150′ is shown including an interface circuit 157 communicating via a connector 124 (generally to a backplane, not shown) and an interface circuit 152 communicating with a port 130, both connected by an internal bus 154 to a processing block 158 including a processor 119a and a memory 119b and memories 121a and 121b. Interface circuit 152 may be used to receive programming information from the programming terminal 132 shown in FIG. 1A. The internal bus 154 also connects to the multi-key switch 200 so that the multi-key switch 200 (as well as each of the interface circuits 157 or 152) may be monitored by the processors 119a, 119b. The processors 119a, 119b can communicate directly with their memory 121a, 121b using a memory bus separate from the internal bus 154. The memories 121a, 121b can comprises a writable non-volatile memory, or be a combination of writable volatile and non-volatile memory.

FIG. 2 shows an example multi-key switch 200 including a dedicated FRC key-switch 203 specifically for the removal of maintenance overrides. FRC reset key-switch 203 has an OFF and a reset position. There is a second FRC key-switch shown as a FRC enable key-switch 202 that has an OF position and an ON position. There is another key-switch shown as a mode switch 201 having a run, PGM and a stop position. When the mode switch 201 is in the run position the safety controller is configured to be in a run mode which overrides the primary controller to implement the secondary controller only in a case of a detected fault in the controlled process or a detected fault in the primary process controller.

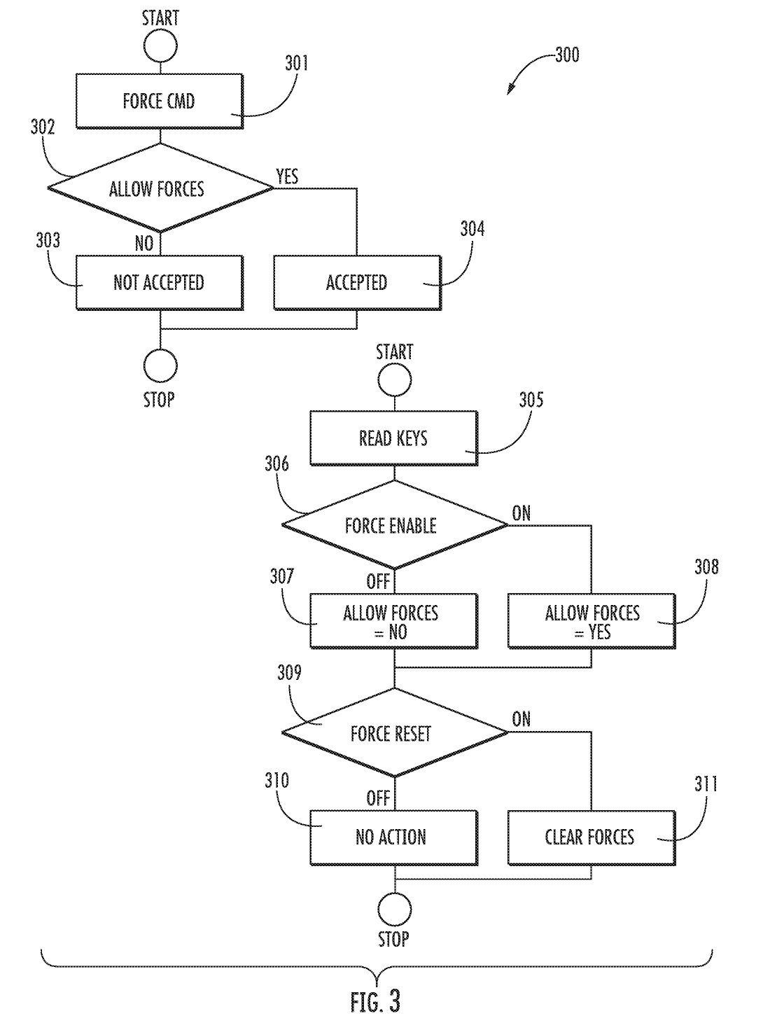

FIG. 3 is a flow chart that shows steps in an example method 300 of process control in a fault-tolerant control system including operating a safety controller with a cyber-secure maintenance override using a disclosed multi-key switch 200 that includes a dedicated FRC reset switch 203 for the removal of active maintenance overrides. Step 301 comprises attempting to enter at least one FRC command (FRC CMD) to a safety controller. Step 302 checks whether the FRC enable key-switch 202 is set to the FRC enable ON position. If the FRC enable is ON, the user's FRC CMD is accepted (entered) in step 304, otherwise the FRC CMD is not accepted (not entered) shown as step 303. Multiple FRC CMDs serving different input and outputs can be accepted and active at a given time. An example of a FRC command is ‘switch output channel 45 to ON’.

Provided the FRC command was accepted in step 304, step 305 is reached which comprises reading the FRC reset key-switch 203 position and FRC enable key-switch 202 position. Step 306 checks whether the FRC enable key-switch 202 read in step 305 is in the ON position. If the FRC enable key-switch 202 is ON, the FRC CMD accepted in step 304 is accepted in step 308 thus becoming an active FRC CMD, otherwise the FRC CMD accepted in step 304 is not accepted in step 307 so that no action is taken in step 307. Step 309 comprises checking the FRC reset key-switch 203 position. If the FRC reset key-switch 203 is ON (from the read in step 305), then the active FRC CMD entered in step 308 is cleared in step 311, otherwise if the FRC reset key-switch 203 is OFF, then no FRC CMD resetting/clearing action is taken and the current FRC CMD is continued.

During a maintenance period multiple FRC CMD for different inputs and outputs are entered and those forces must remain active until maintenance is completed. Without this Disclosure the FRC enable key-switch in step 306 must be kept in the enable position while maintenance is ongoing. This means without this Disclosure a cyber-attack has a FRC CMD attack window open with the duration of the maintenance period. During this attack window an attacker is enabled to enter unintentional FRC CMD. The Disclosure allows the FRC enable key-switch 202 to be returned to the OFF position immediately after accepting a FRC CMD only to be set to the ON position when a genuine FRC CMD is expected. The FRC reset key-switch 203 assures that all forces can be removed when needed.

While various disclosed embodiments have been described above, it should be understood that they have been presented by way of example only, and not as a limitation. Numerous changes to the disclosed embodiments can be made in accordance with the Disclosure herein without departing from the spirit or scope of this Disclosure. Thus, the breadth and scope of this Disclosure should not be limited by any of the above-described embodiments. Rather, the scope of this Disclosure should be defined in accordance with the following claims and their equivalents.

Although disclosed embodiments have been illustrated and described with respect to one or more implementations, equivalent alterations and modifications will occur to others skilled in the art upon the reading and understanding of this specification and the annexed drawings. While a particular feature may have been disclosed with respect to only one of several implementations, such a feature may be combined with one or more other features of the other implementations as may be desired and advantageous for any given or particular application.

1. A safety controller for a control system that runs a controlled process, comprising:
an interface circuit coupled to input/output (IO) devices that are coupled to field devices including sensors and actuators that are coupled to processing equipment involved in said controlled process;
a primary controller including a processor having an associated memory and a parallel connected secondary controller including a secondary processor having an associated secondary memory, each for implementing control loops that automatically take actions by sending control signals to said actuators;
a bus coupling said interface circuit and a mode-switching multi-key switch coupled to said processor, said multi-key switch comprising:
a force (FRC) enable key-switch having a FRC enable On position for entering a maintenance override mode to enable entry of maintenance overrides and an OFF position, and
a FRC reset key-switch having a FRC reset position for removal of said maintenance overrides entered when in said maintenance override mode,
wherein following entry of at least a first said maintenance override after moving said FRC enable key-switch to said FRC enable On position and said FRC enable key-switch is then returned to said OFF position there are no changes to said first maintenance override while new said maintenance overrides cannot be added until said FRC enable key-switch is set to said FRC On position again.

2. The safety controller of claim 1, wherein said multi-key switch further comprises a mode key-switch having a run, program and a stop position, and wherein when in said run position said safety controller is configured to be in a run mode which overrides said primary controller to implement said secondary controller only in a case of a detected fault in said controlled process or a detected fault in said primary process controller.

3. The safety controller of claim 1, wherein said multi-key switch comprises a hardware switch.

4. The safety controller of claim 1, wherein said safety controller comprises a programmable logic controller (PLC).

5. The safety controller of claim 1, further comprising a serial communication port configured to enable direct communication with a programming terminal.

6. The safety controller of claim 1, wherein multiple FRC commands serving different input and outputs can be accepted and active at a given time.

7. A method of process control for a controlled process run by a fault-tolerant control system including field devices including sensors and actuators that are coupled to processing equipment involved in said controlled process, and a safety controller comprising a primary controller including a processor having an associated memory and a parallel connected secondary controller including a secondary processor having an associated second memory both coupled to said processing equipment, said safety controller for implementing a cyber-secure maintenance override,
said safety controller having a multi-key switch including:
a force (FRC) enable key-switch having a FRC enable On position for entering a maintenance override mode to enable entry of maintenance overrides and on OFF position; and
a FRC reset key-switch having a having a FRC reset position for removal of said maintenance overrides entered when in said maintenance override mode,
moving said FRC enable key-switch to said FRC enable On position to enter a maintenance override mode and then initiating enter at least a first said maintenance override, and
returning said FRC enable key-switch to said OFF position without any changes to said first maintenance override while new said maintenance overrides cannot be added until said FRC enable key-switch is set to said FRC On position again.

8. The method of claim 7, wherein said multi-key switch further comprises a mode key-switch having a run, program and a stop position, and wherein when in said run position said safety controller is configured to be in a run mode which overrides said primary controller to implement said secondary controller only in a case of a detected fault in said controlled process or a detected fault in said primary process controller.

9. The method of claim 7, wherein said multi-key switch comprises a hardware switch.

10. The method of claim 7, wherein said safety controller comprises at least one programmable logic controller (PLC).

11. The method of claim 7, wherein said safety controller further comprises a serial communication port configured to enable direct communication with a programming terminal, further comprising programming said safety controller using said programming terminal.

12. The method of claim 7, further comprising accepting and rendering active at a given time multiple FRC commands serving different input and outputs.
